(19) United States
(12) Patent Application Publication
(10) Pub. No.: US 2007/0224945 A1
(43) Pub. Date: Sep. 27, 2007

(54) INTEGRATED CHIP CAPABLE OF TRANSMITTING VOICE SIGNALS BY RADIO WAVES

(76) Inventors: Chien-Hsing Hsieh, Hsin-Chu Hsien (TW); Wen-Hsin Chuang, Hsin-Chu Hsien (TW); Chin-Hsin Yang, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/548,701

(22) Filed: Oct. 12, 2006

(30) Foreign Application Priority Data
Mar. 9, 2006 (TW) 095107998

(51) Int. Cl. H04B 1/02; H04B 1/28

(52) U.S. Cl. 455/91; 455/333

(57) ABSTRACT

An integrated chip of a mobile device includes a substrate, a modulator installed on the substrate for modulating a voice signal, a transmitter installed on the substrate and coupled to the modulator for transmitting the modulated voice signal by radio, and a controller installed on the substrate and coupled to the modulator and the transmitter for controlling the modulator and the transmitter.

### BACKGROUND OF THE INVENTION

1. Field of the Invention

The invention relates to an integrated chip of a mobile device, and more specifically, to an integrated chip capable of transmitting voice signals by radio waves.

2. Description of the Prior Art

With the improvement of technology, various mobile apparatuses, like mobile phones and portable disks, have already had functions of playing music. However, a user needs to use earphones to hear music stored in the mobile apparatus. And when the user wants to use an audio player such as a stereo to play music stored in the mobile apparatus, the user must couple the mobile apparatus to the stereo through an adapter first.

However, the adapter is not so convenient and portable for the user because of its considerable volume and weight. A wire coupled to the adapter and the mobile apparatus is also unpleasant. For example, when the user uses an automobile stereo to play music stored in the mobile device, the disorderly-placed wire coupled to the mobile device and the adapter will lower driving safety.

### SUMMARY OF THE INVENTION

The invention discloses an integrated chip capable of transmitting voice signals by radio waves comprising a substrate; a modulator installed on the substrate for modulating the voice signal; a transmitter installed on the substrate and coupled to the modulator for transmitting the modulated voice signal by the radio waves; and a controller installed on the substrate and coupled to the modulator and the transmitter for controlling the modulator and the transmitter.

The invention further discloses a mobile device capable of transmitting voice signals by radio waves comprising an integrated chip comprising a substrate; a modulator installed on the substrate for modulating the voice signal; a transmitter installed on the substrate and coupled to the modulator for transmitting the modulated voice signal by the radio waves; and a controller installed on the substrate and coupled to the modulator and the transmitter for controlling the modulator and the transmitter; and an antenna coupled to the transmitter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a mobile device according to the present invention.

FIG. 2 is a diagram of an integrated chip of the mobile device in FIG. 1.

FIG. 3 is a diagram of the mobile device in FIG. 1 transmitting the stored music to an audio device.

FIG. 4 is a flowchart according to the present invention.

### DETAILED DESCRIPTION

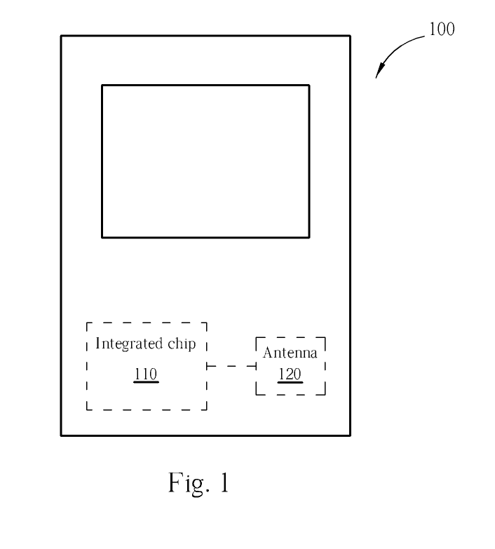

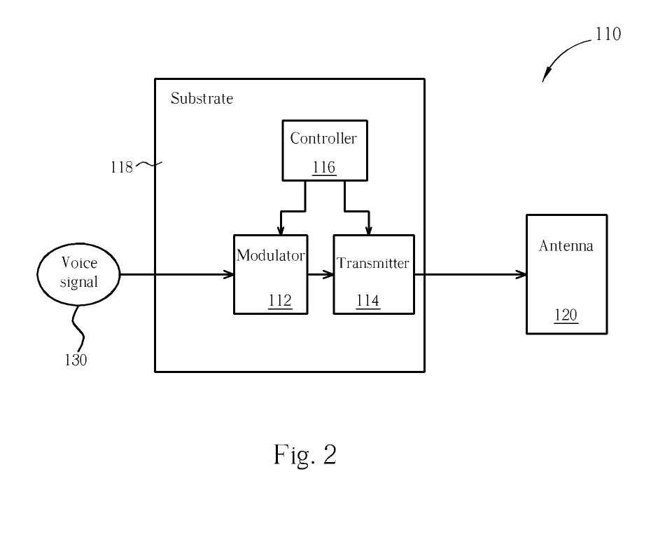

Please refer to FIG. 1 and FIG. 2. FIG. 1 is a diagram of a mobile device 100 according to the present invention. FIG. 2 is a diagram of an integrated chip 110 of the mobile device 100 in FIG. 1. The mobile device 100 comprises an integrated chip 110 and an antenna 120. The integrated chip 110 comprises a substrate 118, a modulator 112 installed on the substrate 118, a transmitter 114 installed on the substrate 118, and a controller 116 installed on the substrate 118. The modulator 112 is used for modulating received voice signals 130. The transmitter 114 is coupled to the modulator 112 and the antenna 120 for transmitting the voice signals modulated by the modulator 112. The transmitter 114 can be an FM transmitter or an AM transmitter. The controller 116 is coupled to the modulator 112 and the transmitter 114 for controlling the modulator 112 and transmitter 114, such as for controlling the transmitting power or the transmitting channel of the transmitter 114.

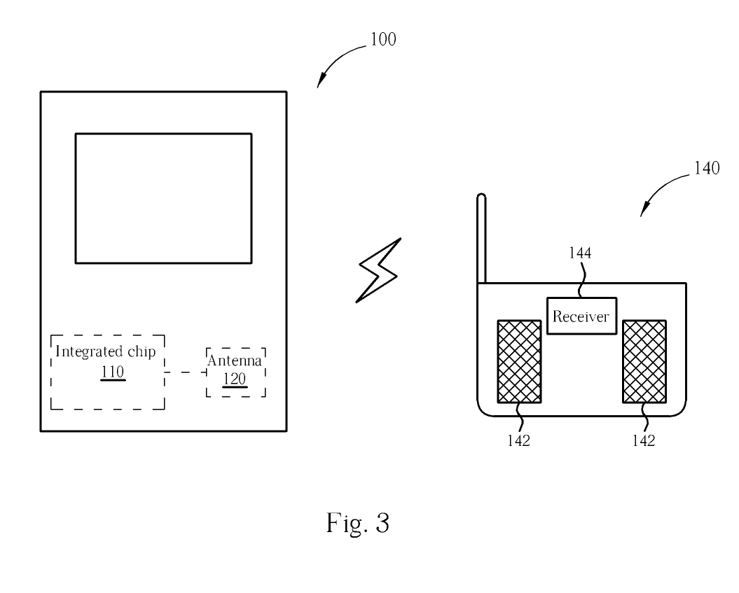

Please refer to FIG. 3. FIG. 3 is a diagram of the mobile device 100 in FIG. 1 transmitting stored music to an audio device 140. The mobile device 100 can transmit voice signals by radio waves. Therefore, when a user wants to use a speaker 142 of the audio device 140 to play music stored in the mobile device 100, the user can open a receiver 144(an AM receiver or an FM receiver) of the audio device 140 and switch the frequency channel of the receiver 144 to a frequency channel set by the controller 116 to receive music transmitted by the mobile device 100. In such a manner, music will be played by the speaker 142 of the audio device 140.

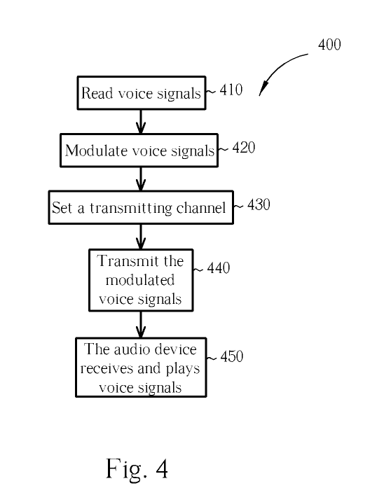

For more detailed description, please refer to FIG. 4. FIG. 4 is a flowchart 400 according to the present invention. Please also refer to FIG. 1, FIG. 2, and FIG. 3 at the same time. The flowchart 400 comprises the following steps.

Step 410: the mobile device 100 reads the voice signals 130 and transmits the voice signals 130 to the modulator 112;

Step 420: the modulator 112 modulates the voice signals 130;

Step 430: the controller 116 sets the transmitting channel of the transmitter 114;

Step 440: the transmitter 114 transmits the modulated voice signals through the antenna 120;

Step 450: the audio device 140 receives the modulated voice signals and plays the modulated voice signals.

Basically, the steps in the flowchart 400 need not be in the exact order shown above and need not be contiguous, that is, other steps can be intermediate. Furthermore, The mobile device 100 can be a mobile phone, an MP3 player, or other music players. The integrated chip 110 can be a multi-media chip or a processing chip of a mobile phone.

Compared with the prior art, the mobile device 100 and the integrated chip 110 of the present invention can transmit the voice signals 130 to the audio device 140 by radio waves instead of relying on an adapter. Therefore, the convenience of the mobile device 100 will be increased. Furthermore, when the user uses an automobile audio to play music stored in the mobile device 100, the music stored in the mobile device 100 can be received and played by the automobile audio without the adapter. That will increase driving safety.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An integrated chip capable of transmitting voice signals by radio waves comprising:
a substrate;
a modulator installed on the substrate for modulating the voice signals;
a transmitter installed on the substrate and coupled to the modulator for transmitting the modulated voice signals by the radio waves; and
a controller installed on the substrate and coupled to the modulator and the transmitter for controlling the modulator and the transmitter.

2. The integrated chip of claim 1, wherein the transmitter is an FM transmitter.

3. The integrated chip of claim 1, wherein the transmitter is an AM transmitter.

4. The integrated chip of claim 1, wherein the integrated chip is a multi-media chip.

5. The integrated chip of claim 1, wherein the integrated chip is a processing chip of a mobile phone.

6. A mobile device capable of transmitting voice signals by radio waves comprising:
an integrated chip comprising:
a substrate;
a modulator installed on the substrate for modulating the voice signals;
a transmitter installed on the substrate and coupled to the modulator for transmitting the modulated voice signals by the radio waves; and
a controller installed on the substrate and coupled to the modulator and the transmitter for controlling the modulator and the transmitter; and
an antenna coupled to the transmitter.

7. The mobile device of claim 6, wherein the transmitter is an FM transmitter.

8. The mobile device of claim 6, wherein the transmitter is an AM transmitter.

9. The mobile device of claim 6, wherein the mobile device is a mobile phone.

10. The mobile device of claim 6, wherein the mobile device is an MP3 player.
